(19) United States
(12) Patent Application Publication
(10) Pub. No.: US 2023/0391034 A1
(43) Pub. Date: Dec. 7, 2023

(54) METHOD FOR DETECTING PUNCTURE IN TIRE CURING BLADDER

(71) Applicant: Toyo Tire Corporation, Itami-shi (JP)

(72) Inventor: Hiroyuki Tobori, Itami-shi (JP)

(73) Assignee: Toyo Tire Corporation, Itami-shi (JP)

(21) Appl. No.: 18/137,565

(22) Filed: Apr. 21, 2023

(30) Foreign Application Priority Data
Jun. 3, 2022 (JP) 2022-090704

(51) Int. Cl. B29D 30/06

(52) U.S. Cl. CPC B29D 30/0662; B29D 30/0654; B29D 2030/0659

(57) ABSTRACT

A method for detecting a puncture in a tire curing bladder during a curing process of heating and pressurizing an uncured tire set in a curing mold from an inside with the bladder, the curing process has the steps of heating the tire with the bladder having a first internal pressure applied by feed of a first curing medium, and pressurizing the tire with the bladder having a second internal pressure applied by feed of a second curing medium after the heating step. The second internal pressure is higher than the first internal pressure. In the pressurizing step, the bladder having the second internal pressure is depressurized at least temporarily, and a sensor detects leakage of the first curing medium to detect a puncture.

### CROSS-REFERENCE TO RELATED APPLICATIONS

The present application claims priority based on Japanese Patent Application No. 2022-90704 filed on Jun. 3, 2022, the contents of which are incorporated herein by reference in its entirety.

### BACKGROUND OF THE INVENTION

### Field of the Invention

The present disclosure relates to a method for detecting a puncture that occurs in a tire curing bladder used for tire cure molding.

### Description of the Related Art

In the related art, a tire curing bladder (hereinafter, simply referred to as “bladder”) that is a rubber bag is used for tire cure molding. The bladder is disposed inside an uncured tire (green tire) set in a curing mold, and is inflated to deform in response to the feed of a curing medium whose pressure and temperature have been adjusted. In a curing process, the bladder that has been inflated to deform presses the tire against a tire molding surface of the curing mold. The tire is heated and pressurized from the outside by the curing mold, and is heated and pressurized from the inside by the bladder.

The bladder may puncture due to aging. When a tire is subjected to cure molding with a bladder in which a puncture has occurred, poor molding may occur due to leakage of the curing medium. It is therefore possible to recognize, after the tire subjected to cure molding is taken out from the curing mold, the occurrence of the puncture on the basis of the poor molding occurring in the tire. When the work of replacing the bladder is started at that timing, it is, however, necessary to stop a curing machine including a time required for pre-setup (replacement preparation), so that a significant decrease in operation rate cannot be avoided.

Patent Documents 1 and 2 each disclose a method for detecting a puncture in a bladder before a tire is taken out from a curing mold. Such methods, however, correspond to a technique for detecting a puncture at the final stage of the curing process, that is, at a stage of discharging the curing medium with which the bladder is filled to the outside. Therefore, even if the work of replacing the bladder is started immediately after the detection of a puncture, it is highly likely to stop the curing machine including the time required for the pre-setup, so that a significant decrease in operation rate cannot be avoided.

### PRIOR ART DOCUMENT

### Patent Document

Patent Document 1: JP-A-2017-39288
Patent Document 2: JP-A-2001-191332

### SUMMARY OF THE INVENTION

The present disclosure has been made in view of the above-described circumstances, and it is therefore an object of the present disclosure to provide a method for detecting a puncture in a tire curing bladder capable of detecting a puncture in a bladder at an early stage of a curing process.

A method of the present disclosure is a method for detecting a puncture in a bladder during a curing process of heating and pressurizing an uncured tire set in a curing mold from an inside with the bladder, the curing process including the steps of heating the tire with the bladder having a first internal pressure applied by feed of a first curing medium, and pressurizing the tire with the bladder having a second internal pressure applied by feed of a second curing medium after the heating step, the second internal pressure being higher than the first internal pressure, and in the pressurizing step, the bladder having the second internal pressure is depressurized at least temporarily, and a sensor detects leakage of the first curing medium to detect a puncture.

### BRIEF DESCRIPTION OF THE DRAWINGS

FIG. 1 is a diagram schematically illustrating an example of a configuration of a curing machine;

FIG. 2 is a graph showing an example of changes in internal pressure of a bladder;

FIG. 3 is an image diagram illustrating steam trapped between the bladder and a tire; and

FIG. 4 is a table showing a specific example concerning details of a curing process time.

### DETAILED DESCRIPTION OF THE PREFERRED EMBODIMENTS

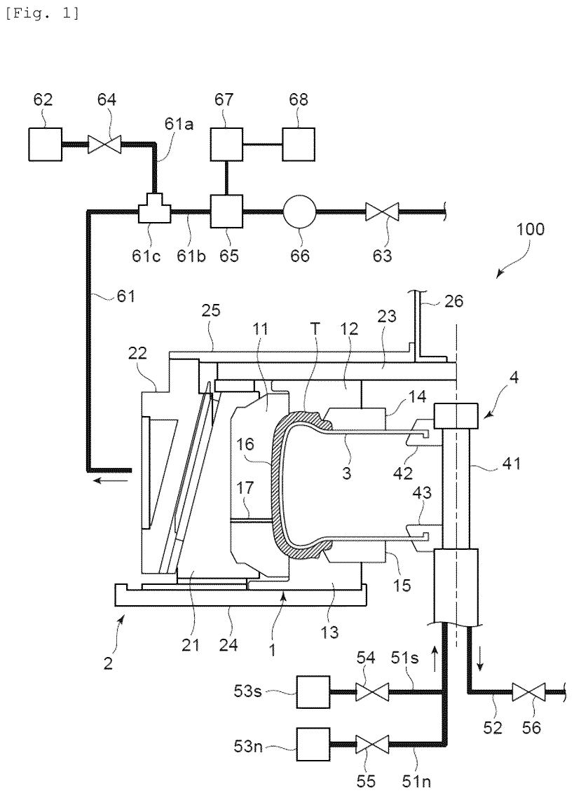

First, an example of a configuration of a curing machine will be described. FIG. 1 schematically illustrates a cross section of a curing machine 100 taken along a tire meridian cross section. The curing machine 100 of the present embodiment includes a curing mold 1 (hereinafter, may be simply referred to as “mold 1”), a container 2 that holds the mold 1, a tire curing bladder 3 (hereinafter, may be simply referred to as “bladder 3”) that is a rubber bag, and a center mechanism 4 provided at a center of the mold 1. In FIG. 1, the mold 1 is in a mold closed state, and a tire T is set with a tire axial direction coincident with a vertical direction. A left direction in FIG. 1 is an outer side in a tire radial direction, and a right direction is an inner side in the tire radial direction.

The mold 1 includes a tread mold 11 for forming a tread of the tire T, side molds 12 and 13 for forming sidewalls of the tire T, and bead rings 14 and 15 to which bead portions of the tire T are fitted. The tread mold 11 includes a plurality of sectors segmented in a tire circumferential direction, and in the mold closed state, the sectors are gathered to be annularly contiguous to each other. The mold 1 is a segmented mold including such a multisegment tread mold 11, but is not limited to such a segmented mold, and may be, for example, a two-piece mold segmented into two in the vertical direction at a center of the tread mold.

The mold 1 includes a tire molding surface 16 that comes into contact with an outer surface of the set tire T. The tire molding surface 16 includes an inner surface of the tread mold 11 and inner surfaces of the side molds 12 and 13. Although not illustrated, concavity and convexity for forming a tread pattern of the tire are provided on the inner surface of the tread mold 11. A vent 17, which is also referred to as a vent hole, is formed to open to the tire molding surface 16 of the mold 1. In FIG. 1, only one vent 17 open to the inner surface of the tread mold 11 is illustrated, but practically, a large number of vents open to the inner surfaces of the tread mold 11 and the side molds 12 and 13 are formed.

The container 2 includes a plurality of segments 21 each provided for a corresponding one of the sectors, and an outer ring 22 disposed outside the segments 21 in the tire radial direction. The tread mold 11 is held by the segments 21. An outer circumferential surface of the segments 21 and an inner circumferential surface of the outer ring 22 that is engaged with the segments 21 are formed by tapered surfaces having the same gradient. Each of the tapered surfaces is inclined outward in the tire radial direction while extending downward. The tread mold 11 is movable in the tire radial direction in response to upward or downward movement of the outer ring 22.

The container 2 further includes an upper platen 23 that supports the side mold 12, a lower platen 24 that supports the side mold 13, and an arm 25 that supports the outer ring 22. The upper platen 23 is movable upward and downward. On a lower surface of the upper platen 23, the segments 21 are supported to be slidable along the tire radial direction. The arm 25 is attached to a guide 26 installed upright on an upper surface of the upper platen 23 to be movable upward and downward. When the arm 25 moves upward or downward relative to the guide 26, the outer ring 22 moves upward or downward relative to the segments 21, and each sector held by the segments 21 moves in the tire radial direction.

Tire cure molding is performed in the mold closed state illustrated in FIG. 1. The container 2 has a heat source such as an electric heater or a steam jacket so as to keep the mold 1 at a high temperature to heat the tire T from the outside. Upon the end of cure molding, the tread mold 11 is increased in diameter (each sector is moved outward in the tire radial direction) while moving the tread mold 11 and the side mold 12 upward by the mechanism of the container 2 described above to transition to a mold open state. In the mold open state, it is possible to take out a tire subjected to cure molding or set an uncured tire.

The bladder 3 is disposed inside the tire T set in the mold 1. When a curing medium to be described later is fed, the bladder 3 is inflated to deform, and when the curing medium is discharged, the bladder 3 is deflated to deform. In a curing process, the tire T is pressed against the tire molding surface 16 by the bladder 3 that has been inflated to deform. The bladder 3 is supported by the center mechanism 4. More specifically, an upper end of the bladder 3 is supported by an upper clamp 42 of the center mechanism 4, and a lower end of the bladder 3 is supported by a lower clamp 43 of the center mechanism 4.

The center mechanism 4 includes a center post 41 extending in the vertical direction at the center of the mold 1. The center post 41 is disposed at an inside in the tire radial direction separate from the mold 1. The upper clamp 42 and the lower clamp 43 are attached to the center post 41. At least a part of each of the upper clamp 42 and the lower clamp 43 is detachable from the center post 41 together with the bladder 3. Although not illustrated, the center post 41 is provided with a feed port of a first feed line 51s and a second feed line 51n for feeding the curing medium into the bladder 3, and a discharge port of a discharge line 52 for discharging the curing medium with which the bladder 3 is filled to the outside.

The curing machine 100 is provided with the first feed line 51s and the second feed line 51n communicating with the inside of the bladder 3 through the feed port, and the discharge line 52 communicating with the inside of the bladder 3 through the discharge port. A feed source 53s of a first curing medium is connected to the first feed line 51s, and a feed source 53n of a second curing medium is connected to the second feed line 51n. The first feed line 51s and the second feed line 51n are provided with feed valves 54 and 55, respectively. The discharge line 52 is provided with a discharge valve 56. An operation of opening/closing each valve can be controlled by a control device (not illustrated).

The curing machine 100 is provided with an exhaust line 61 communicating with the vent 17 formed to open to the tire molding surface 16 of the mold 1. During cure molding, excess air between the outer surface of the tire T and the tire molding surface 16 is discharged from the vent 17 to the outside through the exhaust line 61. A path from the vent 17 to the exhaust line 61 is provided through a gap (for example, a gap between the tread mold 11 and the segments 21, a gap between the side mold 12 and the upper platen 23, a gap between the side mold 13 and the lower platen 24, and the like) in the container 2, but is not limited to such a configuration. A sealing member (not illustrated) is attached to a required portion of the gap in the container 2 so as to allow the above-described excess air to be appropriately sent to the exhaust line 61.

The exhaust line 61 branches off at a midway point, a suction device 62 is connected to one branch path 61a of the exhaust line 61, and an atmosphere release valve 63 is connected to the other branch path 61b. An operation of opening/closing the valve 64 of the suction device 62 provided in the branch path 61a and an operation of opening/closing the atmosphere release valve 63 are controlled by a control device (not illustrated). A sensor 65 is installed on an upstream side of the atmosphere release valve 63 connected to the exhaust line 61. The sensor 65 is installed together with a pressure gauge 66 between a branch point 61c of the exhaust line 61 and the atmosphere release valve 63. The sensor 65 is disposed on an upstream side of the pressure gauge 66, or may be disposed on a downstream side of the pressure gauge 66. In the present embodiment, an example where the sensor 65 is a temperature sensor will be described.

Next, a method for subjecting the tire T to cure molding using the curing machine 100 and detecting a puncture in the bladder 3 during the cure molding will be described. The tire cure molding is performed through a curing process of heating and pressurizing an uncured tire T set in the mold 1. In the curing process, the uncured tire T is heated and pressurized from the outside by the mold 1, and the tire T is heated and pressurized from the inside by the bladder 3. As will be described later, according to the present embodiment, it is possible to detect a puncture in the bladder 3 during the curing process, more specifically, at a relatively early stage of the curing process.

The curing process includes the steps of heating the tire T with the bladder 3 having an internal pressure P1 (corresponding to a first internal pressure) applied by the feed of the first curing medium, and pressurizing the tire T with the bladder 3 having an internal pressure P2 (corresponding to a second internal pressure) applied by the feed of the second curing medium after the heating step, the internal pressure P2 being higher than the internal pressure P1. As an example, the internal pressure P1 is 1.6 MPa, and the internal pressure P2 is 2.4 MPa. As the first curing medium, a fluid serving as a heating medium is used, and steam is preferably used. As the second curing medium, a fluid serving as a pressurizing medium (preferably, a fluid different from the first curing medium) is used, and an inert gas is preferably used as a pressurizing gas. In the present embodiment, an example where steam is used as the first curing medium, and a nitrogen gas (N₂ gas) is used as the second curing medium will be described.

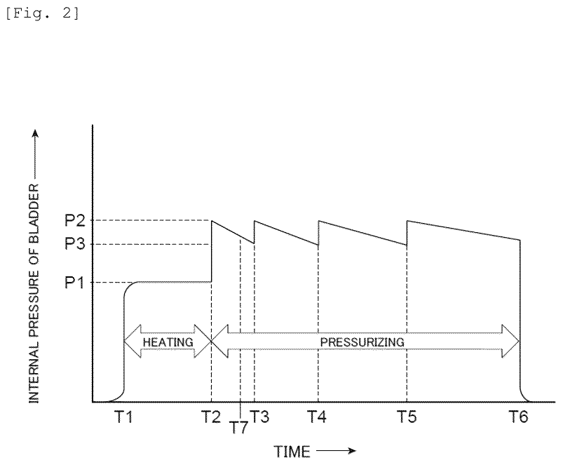

FIG. 2 is a graph showing changes in the internal pressure of the bladder 3. The horizontal axis represents time, and the vertical axis represents the internal pressure of the bladder 3. A range from T1 to T2 on the horizontal axis corresponds to the heating step, and a range from T2 to T6 corresponds to the pressurizing step. After the mold 1 in which the uncured tire T is set is brought into the mold closed state, steam whose pressure and temperature have been adjusted is fed into the bladder 3. The bladder 3 is maintained at the constant internal pressure P1 for a predetermined time (until T2). During this period, the feed valve 54 is open, and the feed valve 55 and the discharge valve 56 are closed. The tire T is heated from the inside by the bladder 3 inflated to deform by the feed of steam and is also heated from the outside with the tire T pressed against the tire molding surface 16.

When the mold 1 is closed (for example, from immediately before the end of mold closing until the lapse of 30 seconds after the start of feed of steam), it is preferable that the suction device 62 be brought into operation with the atmosphere release valve 63 closed to suck excess air between the outer surface of the tire T and the tire molding surface 16. This makes it possible to prevent the occurrence of poor molding due to residual air. The sucked air is sent to a tank of the suction device 62 through the exhaust line 61. At this time, it is possible to check the state of exhaust made by the suction device 62 on the basis of gauge pressure (negative pressure) detected by the pressure gauge 66. The sealing member attached to the gap in the container 2 as described above is effective in enhancing the suction action. Upon the end of suction, the valve 64 of the branch path 61a is closed, and then the atmosphere release valve 63 is opened.

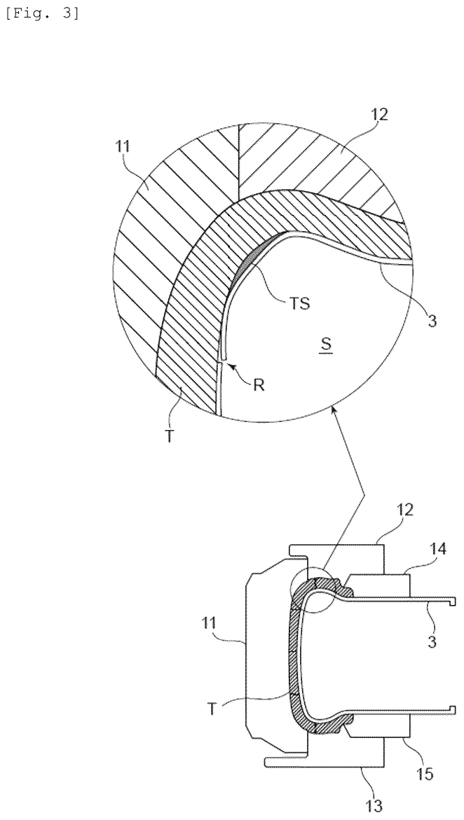

When the bladder 3 punctures, steam leaks from the bladder 3 in the heating step. As in the image diagram illustrated in FIG. 3, steam S leaking out from the bladder 3, however, is likely to be trapped between the outer surface of the bladder 3 and the inner surface of the tire T. Possible causes include that the leakage gradually progresses through a small tear R in the bladder 3 and that the bladder 3 is maintained at the constant internal pressure P1 in the heating step. For the sake of convenience, in the following description, the steam S trapped as described above may be referred to as “steam TS”. Note that the trapped steam TS is deprived of heat by the tire T, and a part or all of the steam TS may be condensed into a drain.

At T2 in FIG. 2, a switch from the heating step to the pressurizing step is made. At the time of the switching, the feed valve 54 is closed, and the feed valve 55 is opened, so that the nitrogen gas whose pressure and temperature have been adjusted is fed into the bladder 3. As a result, the bladder 3 has the higher internal pressure P2, and the tire T can be further pressurized to accelerate cure. Further, in the pressurizing step, the bladder 3 having the internal pressure P2 is depressurized at least temporarily. The bladder 3 is depressurized by closing the feed valve 55 with the discharge valve 56 closed to interrupt the feed of the nitrogen gas so as to reduce the internal pressure of the bladder 3 deprived of heat by the tire T. The first depressurization is performed over a range from T2 to T3 in FIG. 2.

In the present embodiment, the bladder 3 having the internal pressure P2 as described above is depressurized, and the sensor 65 detects leakage of the steam to detect the puncture. Depressurizing the bladder 3 makes the pressure of the trapped steam TS relatively high so as to allow the steam TS to leak from between the bladder 3 and the tire T. For example, the steam TS illustrated in FIG. 3 can move to the right side in the drawing in response to the depressurization of the bladder 3 to leak from between the bladder 3 and the tire T. Note that it is thought that in a case where the trapped steam TS is made into a drain, the drain is re-evaporated in response to the depressurization of the bladder 3, and the pressure of the steam TS becomes relatively high along with an increase in volume in response to the evaporation, thereby causing the steam TS to leak from between the bladder 3 and the tire T.

The sensor 65 detects the temperature of air sent to the sensor 65. When the trapped steam TS leaks in the pressurizing step, air having a higher temperature than usual is sent to the sensor 65, and the steam is accurately detected. Any sensor can be used as the sensor 65 as long as the sensor can detect steam, and the sensor 65 may be, for example, a humidity sensor. A determination unit 67 illustrated in FIG. 1 compares the detection result of the sensor 65 with a preset threshold and determines that a puncture has occurred in the bladder 3 when the detection result exceeds the threshold. The determination result is transmitted to a notification unit 68 capable of outputting sound, light, an image, or the like, and is notified to an operator when a puncture has been detected. Such units are controlled by a control device (not illustrated).

The steam leaking from between the bladder 3 and the tire T enters the gap in the container 2 described above. In the present embodiment, the sensor 65 detects the steam sent through the exhaust line 61 via the gap in the container 2. The sealing member attached to the gap in the container 2 is effective in feeding the leaked steam to the sensor 65 through the exhaust line 61. The branch path 61b is located sufficiently away from the mold 1 and the container 2, and is configured to release air cooled to near the atmosphere temperature (ambient temperature) to the atmosphere. Therefore, when steam having a high temperature (for example, around 100° C.) is contained, a rapid temperature difference is generated, so that the steam can be accurately detected by the sensor 65.

As shown in FIG. 2, in the pressurizing step of the present embodiment, the feed of the nitrogen gas is interrupted immediately after the bladder 3 reaches the internal pressure P2 to depressurize the bladder 3. That is, the feed valve 55 is closed when the bladder 3 reaches the internal pressure P2. According to this method, a timing at which the trapped steam TS leaks out is advanced to allow the puncture in the bladder 3 to be detected at an earlier stage.

Further, in the pressurizing step of the present embodiment, the depressurization of the bladder 3 by interruption of the feed of the nitrogen gas (that is, closing the feed valve 55) and the pressurization of the bladder 3 by resumption of the feed of the nitrogen gas (that is, opening the feed valve 55) are alternately repeated. Specifically, the first depressurization is performed over the range from T2 to T3 in FIG. 2, the feed of the nitrogen gas is resumed at T3 to re-pressurize the bladder 3, and thereafter, the depressurization and the pressurization are alternately repeated in the same manner. As a result, the steam TS that has not leaked in the first depressurization may leak in the second and subsequent depressurization, which increases the possibility of puncture detection. Further, intermittent feed of the nitrogen gas makes it possible to produce an effect of subjecting the inside of the bladder 3 to agitation to make the temperature uniform.

In the pressurizing step of the present embodiment, when the depressurized bladder 3 reaches a predetermined internal pressure P3 (corresponding to a third internal pressure) higher than the internal pressure P1 and lower than the internal pressure P2 (at T3, T4 and T5 in FIG. 2), the feed of the nitrogen gas is resumed to pressurize the bladder 3. As an example, the internal pressure P3 is 2.1 MPa. In FIG. 2, the depressurization is performed a plurality of times (specifically, four times), but the number of times is not particularly limited as long as the bladder 3 is depressurized at least temporarily. As shown in FIG. 2, a time in which the depressurized bladder 3 reaches the internal pressure P3 from the internal pressure P2 gradually increases. This is because the temperature of the tire T increases with the lapse of time, and as a result, the gradient of the decrease in the internal pressure of the bladder 3 due to the heat absorption by the tire T gradually decreases.

At T6 in FIG. 2, in order to terminate the heating and pressurization of the tire T, the discharge valve 56 is opened to discharge the curing medium with which the bladder 3 is filled. As a result, the bladder 3 is deflated to deform, and the mold 1 is brought into the mold open state, so as to allow the cured tire to be taken out from the mold 1. With the techniques disclosed in Patent Documents 1 and 2 described above, a puncture in the bladder 3 is detected at the timing when the curing medium is discharged.

According to the present embodiment, it is possible to detect a puncture in the bladder 3 at an early stage of the curing process (for example, in the range from T2 to T3 in FIG. 2, corresponding to the first half of the curing process). For example, in a case where the puncture is detected at T7, a pre-setup (replacement preparation) can be performed using the subsequent time. It is therefore possible to start the work of replacing the bladder 3 immediately after the cured tire is taken out of the mold 1 or with a short pre-setup performed therebetween, and as a result, downtime of the curing machine 100 can be reduced. Examples of the pre-setup include the work of attaching a spare bladder to a jig (upper and lower clamps) and the work of transporting an assembly of the bladder and the jig to the vicinity of the mold 1 using a transportation device such as a lifter.

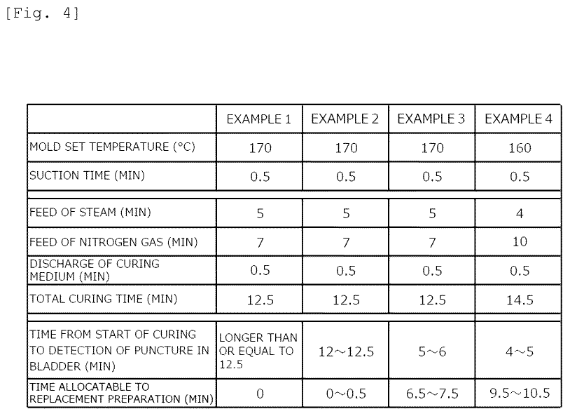

FIG. 4 is a table showing a specific example concerning details of the curing process time. Conditions common to examples 1 to 4 include that the pressure of the steam fed to the bladder in the heating step is 1.6 MPa, and the temperature of the steam is 203° C. The conditions further include that the pressure of the nitrogen gas fed to the bladder in the pressurizing step is 2.3 MPa, and the temperature of the nitrogen gas is room temperature. In the pressurizing step, as shown in FIG. 2, the depressurization and the pressurization of the bladder are alternately repeated, and the nitrogen gas is intermittently fed.

Example 1 is an example where there is no function of detecting a puncture in the bladder. Therefore, the occurrence of a puncture is recognized on the basis of the state of the tire subjected to cure molding taken out from the mold. Therefore, a time allocatable to the replacement preparation (a time allocatable to the pre-setup during the curing process) cannot be obtained. In order to replace the bladder, it is necessary to stop the curing machine including the time required for the pre-setup, so that a significant decrease in operation rate cannot be avoided.

Example 2 is an example where a puncture is detected when the curing medium is discharged from the bladder at the final stage of the curing process. Therefore, even if the time allocatable to the replacement preparation can be obtained, the time is 0.5 minutes or less, so that a time long enough to be allocated to the pre-setup during the curing process cannot be expected. Therefore, in order to replace the bladder, it is necessary to stop the curing machine including the time required for the pre-setup, so that a significant decrease in operation rate cannot be avoided.

Example 3 is an example where a puncture is detected when the bladder is depressurized in the pressurizing step as in the above-described embodiment. Therefore, although the curing time is the same as in Examples 1 and 2, a time of 6.5 to 7.5 minutes allocatable to the replacement preparation is obtained. If the pre-setup is performed within this time, the work of replacing the bladder can be started immediately after the end of the curing process, which contributes to a reduction in the downtime of the curing machine. Further, even if the pre-setup is not completed during the curing process, the pre-setup is shortened by the amount already performed, which also contributes to a reduction in the downtime of the curing machine.

Example 4 is an example where a puncture is detected when the bladder is depressurized in the pressurizing step, as in Example 3. In Example 4, since the time required for the pressurizing step is longer than in Example 3, a time of 9.5 to 10.5 minutes allocatable to the replacement preparation can be obtained. As a result, the time in which the pre-setup can be performed during the curing process is further secured, so that the downtime of the curing machine can be effectively reduced, and a significant decrease in operation rate can be suppressed.

As described above, the method of the present disclosure is a method for detecting a puncture in a bladder 3 during a curing process of heating and pressurizing an uncured tire T set in a curing mold 1 from an inside with the bladder 3, the curing process including the steps of heating the tire T with the bladder 3 having an internal pressure P1 applied by feed of a first curing medium (steam), and pressurizing the tire T with the bladder 3 having an internal pressure P2 applied by feed of a second curing medium (nitrogen gas) after the heating step, the internal pressure P2 being higher than the internal pressure P1, and in the pressurizing step, the bladder 3 having the internal pressure P2 is depressurized at least temporarily, and a sensor 65 detects leakage of the first curing medium (steam TS) to detect a puncture.

According to this method, the depressurization of the bladder 3 in the pressurizing step forces the first curing medium (steam TS) trapped in the heating step to leak out, and the leakage is detected by the sensor 65, thereby making it possible to detect a puncture in the bladder 3 at an early stage of the curing process. As a result, it is possible to reduce the downtime of the curing machine 100 and suppress a significant decrease in operation rate due to the replacement of the bladder 3.

In the method of the above [1], the sensor 65 is preferably a temperature sensor. This makes it possible to detect the high-temperature first curing medium (steam TS) with high accuracy.

In the method of the above [1] or [2], the sensor 65 preferably detects the first curing medium sent through the exhaust line 61 communicating with the vent 17 formed to open to the tire molding surface 16 of the curing mold 1. This method is convenient in detecting the first curing medium (steam TS) leaked out by the depressurization of the bladder 3.

In the method of the above [3], it is preferable that the exhaust line 61 branch off at a midway point, a suction device 62 be connected to one branch path 61a of the exhaust line 61, an atmosphere release valve 63 be connected to the other branch path 61b, and the sensor 65 be installed between a branch point 61c of the exhaust line 61 and the atmosphere release valve 63. This method is convenient in detecting the first curing medium (steam TS) leaked out by the depressurization of the bladder 3.

In the method of any one of the above [1] to [4], in the pressurizing step, the feed of the second curing medium (nitrogen gas) is preferably interrupted immediately after the bladder 3 reaches the second internal pressure P2 to depressurize the bladder 3. According to this method, a timing at which the first curing medium (steam TS) leaks out is advanced to allow the puncture in the bladder 3 to be detected at an earlier stage.

In the method of any one of the above [1] to [5], it is preferable that, in the pressurizing step, the depressurization of the bladder and the pressurization of the bladder be alternately repeated. According to this method, the first curing medium (steam TS) that has not leaked out in the first depressurization of the bladder 3 may leak out in the second and subsequent depressurization, which allows an increase in possibility of puncture detection.

In the method of any one of the above [1] to [5], it is preferable that, in the pressurizing step, the depressurization of the bladder 3 by interruption of the feed of the second curing medium (nitrogen gas) and the pressurization of the bladder 3 by resumption of the feed of the second curing medium (nitrogen gas) be alternately repeated. According to this method, the first curing medium (steam TS) that has not leaked out in the first depressurization of the bladder 3 may leak out in the second and subsequent depressurization, which allows an increase in possibility of puncture detection.

In the method of the above [7], it is preferable that, in the pressurizing step, when the bladder 3 that has been depressurized reaches the internal pressure P3 higher than the internal pressure P1 and lower than the internal pressure P2, the feed of the second curing medium (nitrogen gas) be resumed to pressurize the bladder 3.

In the method of any one of the above [1] to [8], the first curing medium may be steam.

In the method of any one of the above [1] to [9], the second curing medium may be an inert gas.

The method for detecting a puncture of the present disclosure is a method for detecting a puncture in a bladder during the curing process including the heating step and the pressurizing step as described above, and, for the curing process, any well-known curing machine, mold structure, curing condition, or the like may be employed.

The embodiment of the present disclosure has been described above. However, this embodiment should not limit specific configurations according to the present disclosure. The present disclosure provides a scope indicated by the above description of the embodiment as well as the claims, and further includes meanings equivalent to those of the claims and all modifications within the scope.

Therefore, for example, in the above-described embodiment, an example where the suction device 62 connected to the exhaust line 61 is brought into operation at the start of the curing process to suck excess air between the outer surface of the tire T and the tire molding surface 16 has been described, but the configuration is not limited to the example. In the method for detecting a puncture of the present disclosure, such suction is not essential, and thus may be omitted.

Further, in the above-described embodiment, an example where, in order to depressurize the bladder 3 having the internal pressure P2 at least temporarily, the feed valve 55 is closed with the discharge valve 56 closed to interrupt the feed of the nitrogen gas has been described, but the configuration is not limited to the example. For example, instead of or in addition to closing the feed valve 55, the internal pressure of the bladder 3 may be reduced by opening the discharge valve 56.

Further, in the above-described embodiment, an example where the sensor 65 installed between the branch point 61c of the exhaust line 61 and the atmosphere release valve 63 detects the steam TS has been described, but the configuration is not limited to the example. As long as the leakage of the steam TS (first curing medium) can be detected, the sensor 65 may be installed at a different position in the exhaust line 61, or may be installed at a different position other than in the exhaust line 61.

The method for detecting a puncture in a tire curing bladder of the present disclosure is not limited to the above-described embodiment at all, and various modifications and changes can be made without departing from the gist of the present disclosure.

What is claimed is:

1. A method for detecting a puncture in a tire curing bladder during a curing process of heating and pressurizing an uncured tire set in a curing mold from an inside with the bladder,
the curing process comprising the steps of:
heating the tire with the bladder having a first internal pressure applied by feed of a first curing medium, and
pressurizing the tire with the bladder having a second internal pressure applied by feed of a second curing medium after the heating step, the second internal pressure being higher than the first internal pressure,
wherein in the pressurizing step, the bladder having the second internal pressure is depressurized at least temporarily, and a sensor detects leakage of the first curing medium to detect a puncture.

2. The method according to claim 1, wherein the sensor is a temperature sensor.

3. The method according to claim 1, wherein the sensor detects the first curing medium sent through an exhaust line communicating with a vent formed to open to a tire molding surface of the curing mold.

4. The method according to claim 3, wherein the exhaust line branches off at a midway point, a suction device is connected to one branch path of the exhaust line, an atmosphere release valve is connected to another branch path, and the sensor is installed between a branch point of the exhaust line and the atmosphere release valve.

5. The method according to claim 1, wherein in the pressurizing step, the feed of the second curing medium is interrupted immediately after the bladder reaches the second internal pressure to depressurize the bladder.

6. The method according to claim 1, wherein in the pressurizing step, the depressurization of the bladder and the pressurization of the bladder are alternately repeated.

7. The method according to claim 1, wherein in the pressurizing step, the depressurization of the bladder by interruption of the feed of the second curing medium and the pressurization of the bladder by resumption of the feed of the second curing medium are alternately repeated.

8. The method according to claim 7, wherein in the pressurizing step, when the bladder that has been depressurized reaches a third internal pressure higher than the first internal pressure and lower than the second internal pressure, the feed of the second curing medium is resumed to pressurize the bladder.

9. The method according to claim 1, wherein the first curing medium is steam.

10. The method according to claim 1, wherein the second curing medium is an inert gas.
